(19) United States
(12) Patent Application Publication
(10) Pub. No.: US 2013/0003374 A1
(43) Pub. Date: Jan. 3, 2013

(54) LIGHT EMITTING DEVICE AND COMPLEX LENS THEREOF

(76) Inventor: Yen-Chun CHOU, Taipei city (TW)

(21) Appl. No.: 13/170,437

(22) Filed: Jun. 28, 2011

(51) Int. Cl. F21S 4/00; F21V 5/00; F21V 29/00; F21V 7/00; F21V 11/00

(52) U.S. Cl. 362/249.02; 362/296.01; 362/257; 362/294; 362/326

(57) ABSTRACT

A light emitting device includes a light emitting module and a complex lens, which is disposed on the light emitting module and includes first to fourth lens portions. A first group of light beams emitted from the light emitting module and outputted from the first lens portion travels through the first lens portion with total internal reflection, a second group of light beams emitted from the light emitting module and outputted from the fourth lens portion travels through the second, third and fourth lens portions with total internal reflection, a third group of light beams emitted from the light emitting module and outputted from the fourth lens portion travels through the third and fourth lens portions with total internal reflection, and a fourth group of light beams emitted from the light emitting module is outputted from the fourth lens portion.

### BACKGROUND OF THE INVENTION

1. Field of Invention

The invention relates to a light emitting device and a complex lens thereof. More particularly, the invention relates to a light emitting device with a light emitting diode serving as a light source, and a complex lens thereof.

2. Related Art

Recently, the manufacturing processes and the materials of light emitting diodes (LEDs) are continuously improved, so that the light emitting efficiency of the light emitting diode is significantly enhanced. Different from the typical daylight lamp or power-saving light bulb, the light emitting diode has the properties of the low power consumption, the long lifetime, the high security, the short response time and the small size. So, the light emitting diodes have been widely applied to various kinds of electronic products. In one of the applications, the light emitting diode serves as a light emitting lamp to replace the conventional daylight lamp and the daylight bulb.

Referring to FIG. 1, a conventional light emitting diode lamp 1 has a light emitting diode 11 and a circuit board 12. The light emitting diode 11 is disposed on the circuit board 12. The light emitting diode 11 emits light after being driven. However, the light beams outputted from the light emitting diode 11 have orientations, and need to be mounted on a base to facilitate the heat dissipation. Thus, the light irradiation area of the light emitting diode lamp 1 is equal to about 180 degrees, and cannot achieve the light distribution angle of the conventional light bulb approaching 360 degrees. In addition, after the Energy Star of United States announced the specification of the light emitting diode lamp, more and more light emitting diode lamp manufacturers have transferred the originally emphasized light efficiency to the light quality. In other words, more and more attentions have been paid to the light distribution angle of the light emitting diode lamp.

It is therefore a subject of the invention to provide a light emitting device and a complex lens thereof capable of increasing the light output angle to achieve the high-angle light distribution.

### SUMMARY OF THE INVENTION

In view of the foregoing, an object of the invention is to provide a light emitting device and a complex lens thereof capable of increasing the light output angle to achieve the high-angle light distribution.

To achieve the above object, the present invention discloses a light emitting device, which includes a light emitting module and a complex lens. The complex lens is disposed on the light emitting module, and includes a first lens portion, a second lens portion, a third lens portion and a fourth lens portion. The second lens portion surrounds and connects to the first lens portion. The third lens portion surrounds and connects to the second lens portion. The fourth lens portion is surroundingly disposed below the third lens portion. A first group of light beams emitted from the light emitting module and outputted from the first lens portion travels through the first lens portion with total internal reflection. A second group of light beams emitted from the light emitting module and outputted from the fourth lens portion travels through the second lens portion, the third lens portion and the fourth lens portion with total internal reflection. A third group of light beams emitted from the light emitting module and outputted from the fourth lens portion travels through the third lens portion and the fourth lens portion with total internal reflection. A fourth group of light beams emitted from the light emitting module is outputted from the fourth lens portion.

In one embodiment of the invention, the first lens portion, the second lens portion, the third lens portion and the fourth lens portion form an annular chamber.

In one embodiment of the invention, the light emitting module further includes a substrate, three or more light emitting diodes and a driving circuit. The light emitting diodes are arranged on the substrate and disposed in the annular chamber. The driving circuit is electrically connected to the light emitting diodes and lights the light emitting diodes.

In one embodiment of the invention, the light emitting device further includes a lamp shade, a base and a lamp head. The lamp shade has a chamber for accommodating the light emitting module and the complex lens. The base is connected to the lamp shade and supports the light emitting module and the complex lens. The lamp head is connected to the base, and the base has a heat dissipating structure.

In one embodiment of the invention, at least one surface of the complex lens has a micro structure.

In one embodiment of the invention, the first lens portion, the second lens portion, the third lens portion and the fourth lens portion are integrally formed.

In one embodiment of the invention, a light distribution angle of the first lens portion ranges from 0 to 45 degrees and 315 to 360 degrees, a light distribution angle of the second lens portion ranges from 0 to 90 degrees and 270 to 360 degrees, a light distribution angle of the third lens portion ranges from 90 to 150 degrees and 210 to 270 degrees, and a light distribution angle of the fourth lens portion ranges from 0 to 90 degrees and 270 to 360 degrees.

In one embodiment of the invention, the first group of light beams is outputted through refraction of a first surface of the first lens portion, total internal reflection of a second surface of the first lens portion, and refraction of a third surface of the first lens portion.

In one embodiment of the invention, the second group of light beams is outputted through refraction of a first surface of the second lens portion, total internal reflection of a second surface of the second lens portion, transmission of the third lens portion and refraction of a first surface of the fourth lens portion.

In one embodiment of the invention, the third group of light beams is outputted through refraction of a first surface of the third lens portion, total internal reflection of a second surface of the third lens portion, and refraction of the first surface of the fourth lens portion.

In one embodiment of the invention, the fourth group of light beams is outputted through refraction of a second surface of the fourth lens portion and refraction of the first surface of the fourth lens portion.

To achieve the above object, the present invention also discloses a complex lens, which includes a first lens portion, a second lens portion, a third lens portion and a fourth lens portion. The second lens portion surrounds and connects to the first lens portion. The third lens portion surrounds and connects to the second lens portion. The fourth lens portion is surroundingly disposed below the third lens portion.

In one embodiment of the invention, the first lens portion, the second lens portion, the third lens portion and the fourth lens portion form an annular chamber.

In one embodiment of the invention, the first lens portion, the second lens portion, the third lens portion and the fourth lens portion are integrally formed.

As mentioned above, the light emitting device and the complex lens thereof according to the invention have the following features. The first group of light beams emitted from the light emitting module and outputted from the first lens portion travels through the first lens portion with total internal reflection. The second group of light beams emitted from the light emitting module and outputted from the fourth lens portion travels through the second lens portion with total internal reflection. The third group of light beams emitted from the light emitting module and outputted from the fourth lens portion travels through the third lens portion and the fourth lens portion with total internal reflection. The fourth group of light beams emitted from the light emitting module is outputted from the fourth lens portion. Thus, the light output angle can be increased, and the light emitting device with the high-angle light distribution can be implemented.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a conventional light emitting diode lamp;

FIG. 2A is a schematic illustration showing a light emitting device according to a preferred embodiment of the invention;

FIG. 2B is a cross-sectional view showing the light emitting device according to the preferred embodiment of the invention;

FIGS. 3A to 3C are schematic illustrations showing modifications of a light emitting module according to the preferred embodiment of the invention;

FIGS. 4A to 4D are schematic illustrations showing a complex lens according to the preferred embodiment of the invention; and

FIG. 5 is a schematic illustration showing a light emitting device according to the preferred embodiment of the invention.

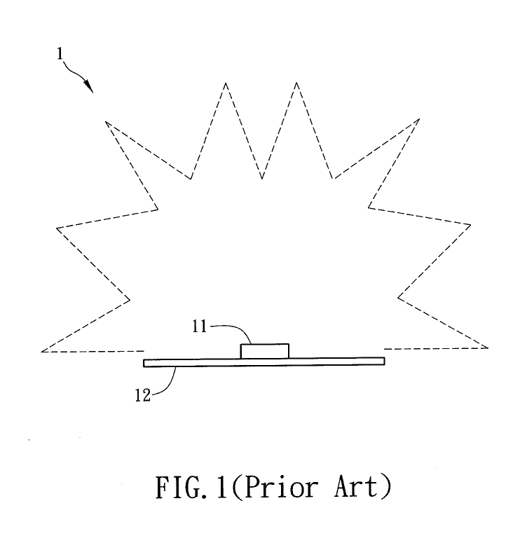

### DETAILED DESCRIPTION OF THE INVENTION

The present invention will be apparent from the following detailed description, which proceeds with reference to the accompanying drawings, wherein the same references relate to the same elements.

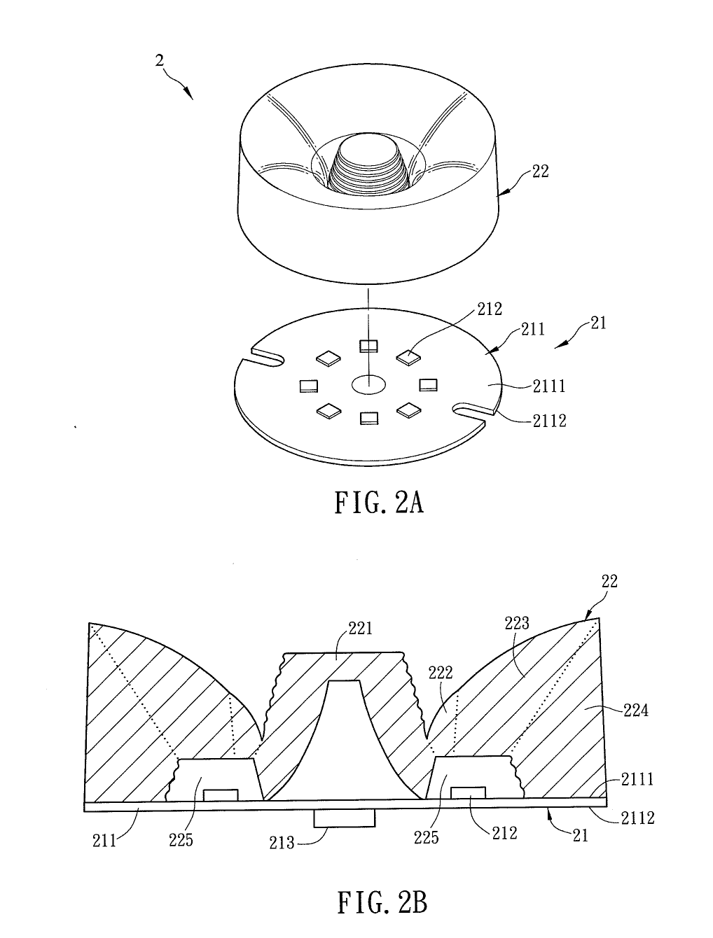

FIGS. 2A and 2B are respectively a schematic illustration and a cross-sectional view showing a light emitting device 2 according to a preferred embodiment of the invention. Referring first to FIGS. 2A and 2B, the light emitting device 2 includes a light emitting module 21 and a complex lens 22.

In this embodiment, the light emitting module 21 has a substrate 211, eighth light emitting diodes 212 and a driving circuit 213. Herein, the substrate 211 may be a circuit board, and the light emitting diodes 212 are mounted on a surface 2111 of the substrate 211 in an annular manner. In the application, in order to reduce the size of the light emitting module 21, the light emitting diodes 212 may be chip-type light emitting diodes. Of course, the light emitting diodes 212 may also be dual in-line package (DIP) light emitting diodes. In addition, the driving circuit 213 is disposed on the substrate 211 and electrically connected to the light emitting diodes 212, and is preferably disposed on the other surface 2112 disposed opposite the light emitting diodes 212. Through the interconnections on the substrate 211, the driving circuit 213 controls the light emitting diodes 212 to turn on or off.

It is to be noted that the light emitting module 21 has eight light emitting diodes 212 in this example embodiment. In practice, however, more or fewer light emitting diodes may be adopted according to the requirement and design consideration of the product. In general, this embodiment is adapted to more than three light emitting diodes. In addition, the invention does not intend to restrict the connections between the light emitting diodes of the light emitting module.

Furthermore, the complex lens 22 is disposed on the light emitting module 21 and covers the light emitting diodes 212. The material of the complex lens 22 may be a light-permeable polymeric substance, such as polymethyl methacrylate (PMMA), polystyrene (PS), methyl-methacrylate-styrene (MS), polycarbonate (PC) or the like.

Referring again to FIG. 2B, the complex lens 22 of this embodiment includes a first lens portion 221, a second lens portion 222, a third lens portion 223 and a fourth lens portion 224. The first lens portion 221 is disposed on a central portion of the complex lens 22. The second lens portion 222 surrounds and is connected to the first lens portion 221. The third lens portion 223 surrounds and is connected to the second lens portion 222. The fourth lens portion 224 is surroundingly disposed below the third lens portion 223. The first lens portion 221, the second lens portion 222, the third lens portion 223 and the fourth lens portion 224 form an annular chamber 225, in which the light emitting diodes 212 is disposed. In addition, the first lens portion 221, the second lens portion 222, the third lens portion 223 and the fourth lens portion 224 may be integrally formed.

In this embodiment, a first group of light beams emitted from the light emitting diodes 212 of the light emitting module 21 and outputted from the first lens portion 221 travels through the first lens portion 221 with at least one time of total internal reflection (TIR). A second group of light beams emitted from the light emitting module 21 and outputted from the fourth lens portion 224 travels through the second lens portion 222 and the third lens portion 223 with at least one time of total internal reflection in the second lens portion 222. A third group of light beams emitted from the light emitting module 21 and outputted from the fourth lens portion 224 travels through the third lens portion 223 and the fourth lens portion 224 with at least one time of total internal reflection in the third lens portion 223. A fourth group of light beams emitted from the light emitting module 21 travels through the fourth lens portion 224 and is outputted from the fourth lens portion 224.

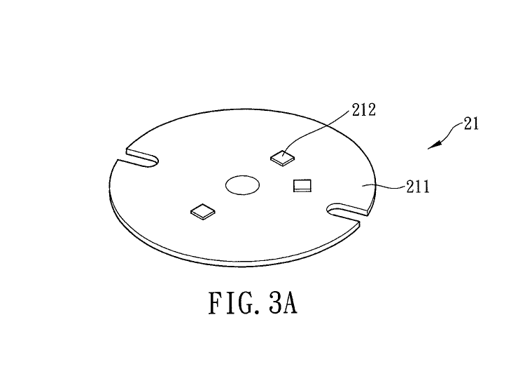

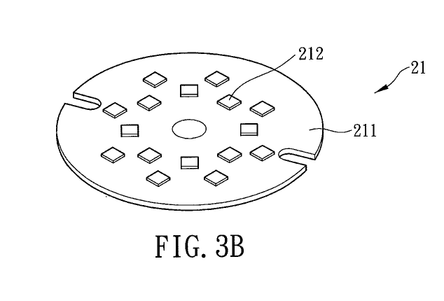

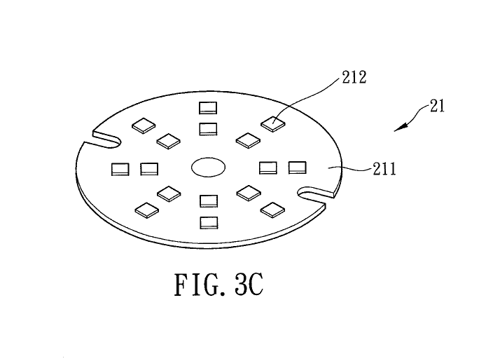

In addition, it is to be noted that, in practice, the light emitting diodes 212 of the light emitting module 21 may have different arrangements according to the requirement or design consideration of the product. Three implemented architectures of the light emitting module 21 will be described with reference to FIGS. 3A to 3C.

As shown in FIG. 3A, the light emitting module 21 has three light emitting diodes 212. The light emitting diodes 212 are disposed on the substrate 211, and the three light emitting diodes 212 are unequally spaced. Next, as shown in FIG. 3B, the light emitting module 21 has sixteen light emitting diodes 212, which are arranged in two rings in a staggered manner. As shown in FIG. 3C, the light emitting module 21 also has sixteen light emitting diodes 212. What is different from FIG. 3B is that the light emitting diodes 212 of FIG. 3C arranged in two rings are arranged in the same radial directions.

In this embodiment, the light emitting diodes 212 of the light emitting module 21 are equally spaced and arranged on the substrate 211 in an irregular manner and the dual-ring manner. In addition, the light emitting diodes 212 may further be mounted on the substrate 211 in three or more than three rings.

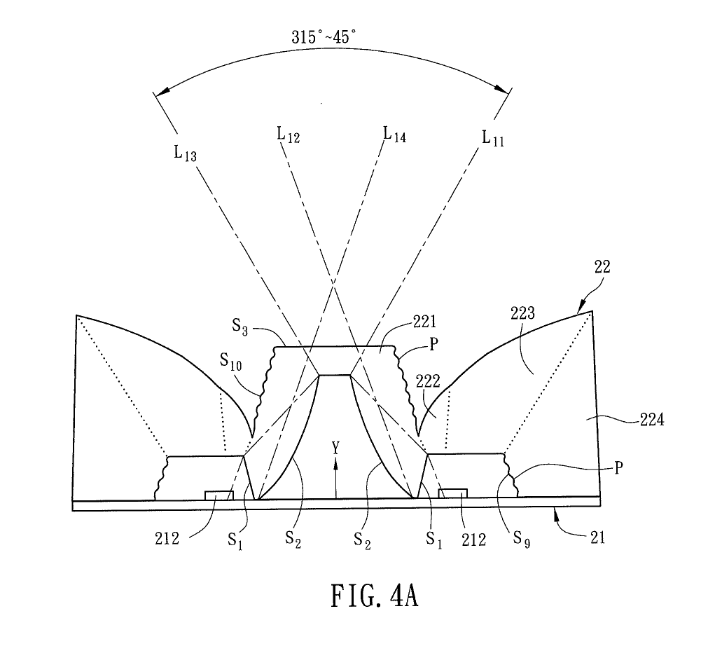

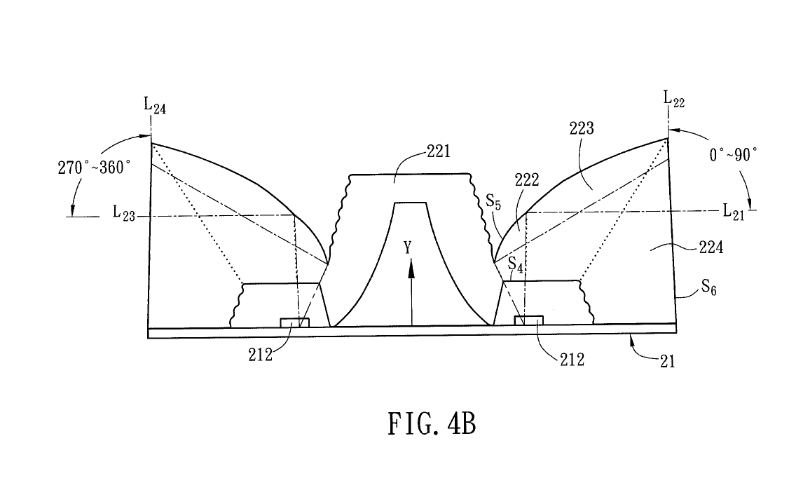

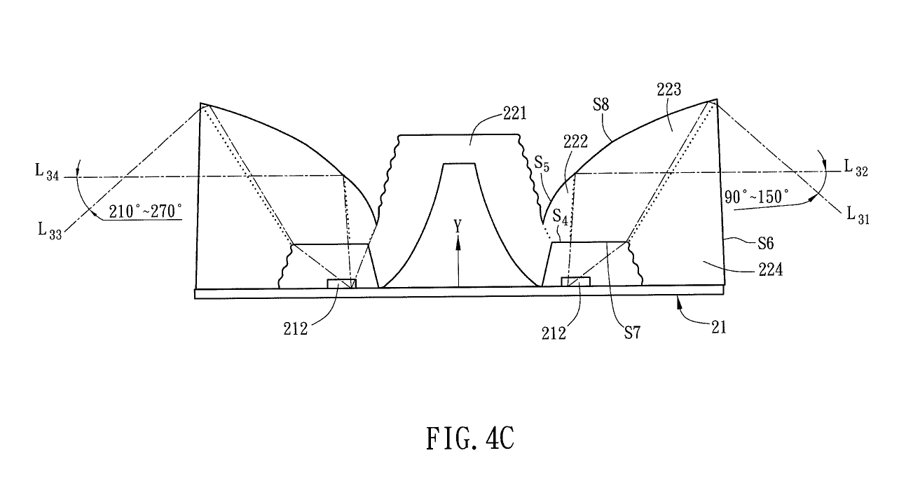

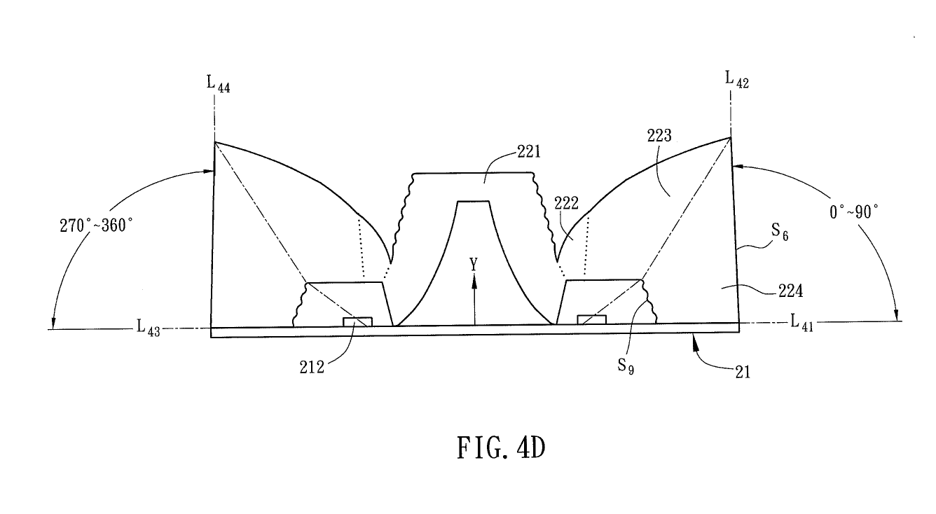

Next, the relationships between the first lens portion 221, the second lens portion 222, the third lens portion 223 and the fourth lens portion 224 of the complex lens 22 and the first group of light beams L₁₁ to L₁₄, the second group of light beams L₂₁ to L₂₄, the third group of light beams L₃₁ to L₃₄ and the fourth group of light beams L₄₁ to L₄₄ will be described with reference to FIGS. 4A to 4D, wherein the following angles are based on the Y-axis.

As shown in FIG. 4A, the first lens portion 221 of this embodiment has a first surface S₁, a second surface S₂ and a third surface S₃. The first group of light beams L₁₁ to L₁₄ emitted from the light emitting diodes 212 of the light emitting module 21 is refracted by the first surface S₁, reflected by the second surface S₂ with at least one total internal reflection, and then refracted by and outputted from the third surface S₃. Thus, the first group of light beams L₁₁ to L₁₄ outputted from the third surface S₃ can cover the range of 90 degrees. In other words, the light distribution angle of the first lens portion 221 ranges from 0 to 45 degrees and 315 to 360 degrees.

As shown in FIG. 4B, the second lens portion 222 has a first surface S₄ and a second surface S₅. The second group of light beams L₂₁ to L₂₄ emitted from the light emitting diodes 212 is refracted by the first surface S₄ of the second lens portion 222, is reflected by the second surface S₅ of the second lens portion 222 with at least one total internal reflection, traveling through the third lens portion 223, and is then refracted by and outputted from a first surface S₆ of the fourth lens portion 224. The irradiation area of the second group of light beams L₂₁ to L₂₄ traveling through the second lens portion 222 ranges from 0 to 90 degrees and 270 to 360 degrees.

As shown in FIG. 4C, the third lens portion 223 has a first surface S₇ and a second surface S₈. The third group of light beams L₃₁ to L₃₄ emitted from the light emitting diodes 212 is refracted by the first surface S₇ of the third lens portion 223 and reflected by the second surface S₈ of the third lens portion 223 with at least one total internal reflection, and then refracted by and outputted from the first surface S₆ of the fourth lens portion 224. Thus, the third lens portion 223 distributes the third group of light beams L₃₁ to L₃₄ to make its irradiation area range from 90 to 150 degrees and 210 to 270 degrees. In addition, the first surface S₄ of the second lens portion 222 and the first surface S₇ of the third lens portion 223 in this embodiment extend to each other, and the second surface S₅ of the second lens portion 222 and the second surface S₈ of the third lens portion 223 have different radii of curvatures.

As shown in FIG. 4D, the fourth lens portion 224 includes the first surface S₆ and a second surface S₉. The fourth group of light beams L₄₁ to L₄₄ emitted from the light emitting diodes 212 is refracted by the second surface S₉ of the fourth lens portion 224 and then refracted by and outputted from the first surface S₆ of the fourth lens portion 224. Thus, the fourth lens portion 224 distributes the fourth group of light beams L₄₁ to L₄₄ to make its irradiation area range from 0 to 90 degrees and 270 to 360 degrees.

In addition, it is to be noted that at least one surface of the complex lens 22 has a micro structure P, as shown in FIG. 4A. In this example embodiment, the surface S₁₀ of the first lens portion 221 neighboring the third surface S₃ has the micro structure P, and the second surface S₉ of the fourth lens portion 224 has the micro structure P. The provision of the micro structure P can effectively homogenize the light beams emitted from the light emitting diodes 212. The micro structure P may be formed by way of ink printing, etching, laser, precision mechanical machining or the like. In addition, the cross-sectional area of the micro structure P may have a wavy shape, an arc shape, a linear shape, a triangular shape, a polygonal shape or an irregular shape.

Consequently, according to the above-mentioned structure, the complex lens 22 can effectively increase the light output angle of the light emitting diodes 212, and thus enhance the light emitting quality of the light emitting device 2.

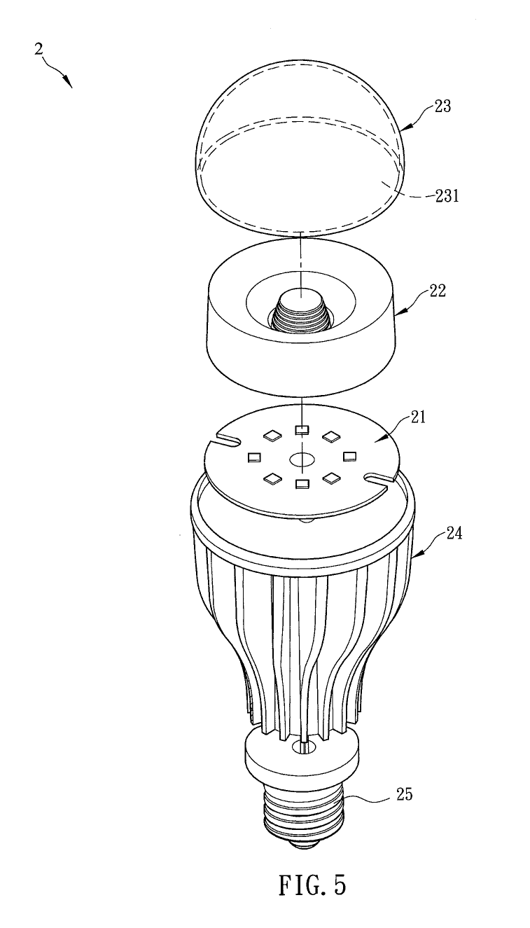

Referring next to FIG. 5, the light emitting device 2 further includes a lamp shade 23, a base 24 and a lamp head 25. The lamp shade 23 has a chamber 231 for accommodating the light emitting module 21 and the complex lens 22. The material of the lamp shade 23 may be glass or the light-permeable polymeric substance. The base 24 is connected to the lamp shade 23 and supports the light emitting module 21 and the complex lens 22. In addition, the material of the base 24 may be the metal material, the plastic material or a combination thereof, and the base 24 may be an integrally formed member or the member composed of several parts. In practice, the base 24 may have several openings or fins or may be other types of heat dissipating structure for the thermal convection and heat conductivity. In addition, the lamp head 25 has one end connected to the base 24, and the other end connected to a lamp holder (not shown), and receives an external power for the lighting of the light emitting module 21.

In addition, another embodiment of the invention discloses a complex lens including a first lens portion, a second lens portion, a third lens portion and a fourth lens portion. The second lens portion surrounds and is connected to the first lens portion. The third lens portion surrounds and is connected to the second lens portion. The fourth lens portion is surroundingly disposed below the third lens portion.

Because the features and effects of the complex lens of this embodiment are the same as those of the complex lens of the previous embodiment, detailed descriptions thereof will be omitted.

In summary, the light emitting device and the complex lens thereof according to the invention have the following features. The first group of light beams emitted from the light emitting module and outputted from the first lens portion travels through the first lens portion with total internal reflection. The second group of light beams emitted from the light emitting module and outputted from the fourth lens portion travels through the second lens portion with total internal reflection. The third group of light beams emitted from the light emitting module and outputted from the fourth lens portion travels through the third lens portion and the fourth lens portion with total internal reflection. The fourth group of light beams emitted from the light emitting module is outputted from the fourth lens portion. Thus, the light output angle can be increased, and the light emitting device with the high-angle light distribution can be implemented.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting device, comprising:
a light emitting module; and
a complex lens disposed on the light emitting module, the complex lens comprising:
a first lens portion,
a second lens portion surrounding and being connected to the first lens portion,
a third lens portion surrounding and being connected to the second lens portion, and
a fourth lens portion surroundingly disposed below the third lens portion;
wherein a first group of light beams emitted from the light emitting module and outputted from the first lens portion travels through the first lens portion with total internal reflection, a second group of light beams emitted from the light emitting module and outputted from the fourth lens portion travels through the second lens portion, the third lens portion and the fourth lens portion with total internal reflection, a third group of light beams emitted from the light emitting module and outputted from the fourth lens portion travels through the third lens portion and the fourth lens portion with total internal reflection, and a fourth group of light beams emitted from the light emitting module is outputted from the fourth lens portion.

2. The light emitting device according to claim 1, wherein the first lens portion, the second lens portion, the third lens portion and the fourth lens portion form an annular chamber.

3. The light emitting device according to claim 2, wherein the light emitting module further comprises:
a substrate;
three or more light emitting diodes arranged on the substrate and disposed in the annular chamber; and
a driving circuit, which is electrically connected to the light emitting diodes and lights the light emitting diodes.

4. The light emitting device according to claim 1, further comprising:
a lamp shade having a chamber for accommodating the light emitting module and the complex lens;
a base, which is connected to the lamp shade and supports the light emitting module and the complex lens; and
a lamp head connected to the base.

5. The light emitting device according to claim 4, wherein the base has a heat dissipating structure.

6. The light emitting device according to claim 1, wherein at least one surface of the complex lens has a micro structure.

7. The light emitting device according to claim 1, wherein the first lens portion, the second lens portion, the third lens portion and the fourth lens portion are integrally formed.

8. The light emitting device according to claim 1, wherein a light distribution angle of the first lens portion ranges from 0 to 45 degrees and 315 to 360 degrees, a light distribution angle of the second lens portion ranges from 0 to 90 degrees and 270 to 360 degrees, a light distribution angle of the third lens portion ranges from 90 to 150 degrees and 210 to 270 degrees, and a light distribution angle of the fourth lens portion ranges from 0 to 90 degrees and 270 to 360 degrees.

9. The light emitting device according to claim 1, wherein the first group of light beams is outputted through refraction of a first surface of the first lens portion, total internal reflection of a second surface of the first lens portion, and refraction of a third surface of the first lens portion.

10. The light emitting device according to claim 9, wherein the second group of light beams is outputted through refraction of a first surface of the second lens portion, total internal reflection of a second surface of the second lens portion, transmission of the third lens portion and refraction of a first surface of the fourth lens portion.

11. The light emitting device according to claim 10, wherein the third group of light beams is outputted through refraction of a first surface of the third lens portion, total internal reflection of a second surface of the third lens portion, and refraction of the first surface of the fourth lens portion.

12. The light emitting device according to claim 11, wherein the fourth group of light beams is outputted through refraction of a second surface of the fourth lens portion and refraction of the first surface of the fourth lens portion.

13. A complex lens, comprising:
a first lens portion;
a second lens portion surrounding and being connected to the first lens portion;
a third lens portion surrounding and being connected to the second lens portion; and
a fourth lens portion surroundingly disposed below the third lens portion.

14. The complex lens according to claim 13, wherein the first lens portion, the second lens portion, the third lens portion and the fourth lens portion form an annular chamber.

15. The complex lens according to claim 13, wherein the first lens portion, the second lens portion, the third lens portion and the fourth lens portion are integrally formed.
